(19) United States
(12) Patent Application Publication
(10) Pub. No.: US 2023/0393826 A1
(43) Pub. Date: Dec. 7, 2023

(54) FAST RETRIEVING HIERARCHICAL COMPONENTS ON MULTI-TENANT CROSS REGION MULTI-CLOUD

(71) Applicant: SAP SE, Walldorf (DE)

(72) Inventors: Xiang Cai, Singapore (SG); Qiu Shi Wang, Singapore (SG); Jin You Zhu, Singapore (SG)

(21) Appl. No.: 17/830,588

(22) Filed: Jun. 2, 2022

(51) Int. Cl. G06F 8/61

(52) U.S. Cl. CPC G06F 8/61

(57) ABSTRACT

Methods, systems, and computer-readable storage media for Methods, systems, and computer-readable storage media for executing a component packing function to provide an installation package executable to install an instance of an application and including an inner function executable to retrieve components in a set of components of the application, and providing a mapping table that, for each component, associates a locator to an identifier, and, receiving, by an installer within a cloud platform, the installation package, and processing, by the installer, the installation package to install a first instance of the application on a computing device of the cloud platform by determining, for at least one component in the set of components, a respective identifier based on a respective locator using the mapping table, retrieving, by the inner function, the at least one component from a component repository based on the respective identifier, and installing the at least one component on the computing device.

### BACKGROUND

Enterprises can use enterprise applications to support and execute operations. Enterprise applications can be deployed in cloud computing environments, which includes execution of the enterprise applications within a data center of a cloud-computing provider (e.g., as part of an infrastructure-as-a-service (IaaS) offering). Cloud computing can be described as Internet-based computing that provides shared computer processing resources, and data to computers and other devices on demand. Users can establish respective sessions, during which processing resources, and bandwidth are consumed.

Applications that execute on cloud platforms are typically composed of several components in a hierarchical structure. For example, a main component can include several sub-components, and each sub-component further includes next level sub-components recursively. These components can include reusable components that can include vendor-provided components, customized components (so-called homebrew components), and/or components developed by third-parties. To install an application and consume components, a traditional approach includes packing all of the components into an installation package during build-time and loading the hierarchical components from the installation package recursively during runtime.

### SUMMARY

Implementations of the present disclosure are directed to packing and unpacking of applications including hierarchical components. More particularly, implementations of the present disclosure are directed to lean installation packages for runtime retrieval of hierarchical components of applications running on multi-tenant, cross-region multi-cloud platforms.

In some implementations, actions include, during a build-time, executing a component packing function to provide an installation package that is executable to install an instance of an application on a computing device, the installation package including an inner function that is executable to retrieve components in a set of components that provide functionality of the application, and providing a mapping table that, for each component in the set of components, associates a locator to an identifier, and, during a runtime, receiving, by an installer within a cloud platform, the installation package, and processing, by the installer, the installation package to install a first instance of the application on a computing device of the cloud platform by determining, for at least one component in the set of components, a respective identifier based on a respective locator using the mapping table, retrieving, by the inner function, the at least one component from a component repository based on the respective identifier, and installing the at least one component on the computing device. Other implementations of this aspect include corresponding systems, apparatus, and computer programs, configured to perform the actions of the methods, encoded on computer storage devices.

These and other implementations can each optionally include one or more of the following features: each component in the set of components is stored in the component repository; the component repository is provided in multiple datacenters accessible to the cloud platform; a component in the set of components includes a sub-application; actions further include processing, by the installer, the installation package to install a second instance of the application on another computing device of the cloud platform; all components in the set of components are installed to provide the first instance of the application; and a sub-set of components in the set of components is installed to provide the first instance of the application, and one or more components of the set of components are installed after the sub-set of components, in response to functionality of the one or more components being required during execution of the instance of the application.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIG. 3 depicts example respective representations of build-time and runtime of an application in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure. Like reference symbols in the various drawings indicate like elements.

### DETAILED DESCRIPTION

Implementations of the present disclosure are directed to packing and unpacking of applications including hierarchical components. More particularly, implementations of the present disclosure are directed to lean installation packages runtime retrieval of hierarchical components of applications running on multi-tenant, cross-region multi-cloud platforms. Implementations can include actions of, during a build-time, executing a component packing function to provide an installation package that is executable to install an instance of an application on a computing device, the installation package including an inner function that is executable to retrieve components in a set of components that provide functionality of the application, and providing a mapping table that, for each component in the set of components, associates a locator to an identifier, and, during a runtime, receiving, by an installer within a cloud platform, the installation package, and processing, by the installer, the installation package to install a first instance of the application on a computing device of the cloud platform by determining, for at least one component in the set of components, a respective identifier based on a respective locator using the mapping table, retrieving, by the inner function, the at least one component from a component repository based on the respective identifier, and installing the at least one component on the computing device.

To provide further context for implementations of the present disclosure, and as introduced above, enterprises can use enterprise applications to support and execute operations. Enterprise applications can be deployed in cloud computing environments, which includes execution of the enterprise applications within a data center of a cloud-computing provider (e.g., as part of an infrastructure-as-a-service (IaaS) offering). Cloud computing can be described as Internet-based computing that provides shared computer processing resources, and data to computers and other devices on demand. Users can establish respective sessions, during which processing resources, and bandwidth are consumed.

Applications that execute on cloud platforms are typically composed of several components in a hierarchical structure. For example, a main component can include several sub-components, and each sub-component further includes next level sub-components recursively. These components can include reusable components that can include vendor-provided components, customized components (so-called homebrew components), and/or components developed by third-parties. To install an application and consume components, a traditional approach includes packing all of the components into an installation package during build-time and loading the hierarchical components from the installation package recursively during runtime.

There are disadvantages to traditional approaches in consuming components. For example, some applications can include hundreds, if not thousands of components. As a result, an installation package (also referred to as an application package) itself can be relatively larger in terms of memory footprint. This results in consumption of technical resources such as storage, as well as network bandwidth and execution to handle the installation package and install components (e.g., transmit the installation package over a network and install components on a computing device). As another example, recursively loading components that are in a hierarchical structure during runtime can incur a significant runtime performance penalty. That is, an amount of processing that is required to unpack the components is inefficient in terms of time and technical resources. As another example, different instances of an application within a cloud platform may need to pack the same components repeatedly, an installation package for each instance. This also results in resource waste and is difficult to support multi-tenant cloud usage patterns, in which individual tenants require a respective instance of an application.

In view of the above context, implementations of the present disclosure provide for runtime retrieval of of hierarchical components of applications running on multi-tenant, cross-region multi-cloud platforms. In accordance with implementations of the present disclosure, and as described in further detail herein, instead of packing all of the components physically in hierarchical structure, an installation package includes a component retrieval function that is executed in an application runtime when the application is started to retrieve components from a component repository. This can include an initial loading of base components, for example. In some examples, one or more components are retrieved on-the-fly, which can be described as loading of components only when they are required during runtime.

As described in further detail herein, instead of packing almost the same set of components for every application instance repeatedly in an installation package, all the components are stored in a component repository and are retrieved therefrom for installation. Because the installation package is absent components, the installation package can be considered lean in terms of size (e.g., memory footprint). In some examples, multiple component repositories can be provided and can be distributed and hot-swapped across different geographic regions on multi-cloud infrastructures with high availability and low latency. In this manner, implementations of the present disclosure support multi-tenant cloud usage patterns and while reducing resource waste in cloud platforms. In some implementations, a single source of truth mapping table is provided to manage retrieval of components from component repositories. Instead of time consuming recursive loading of required components in hierarchical structure during runtime, the component retrieval function can retrieve components using a hash algorithm at a relatively fast rate.

Implementations of the present disclosure are described in further detail herein with reference to Java and Javascript. It is contemplated, however, that implementations of the present disclosure can be realized using any appropriate programming language.

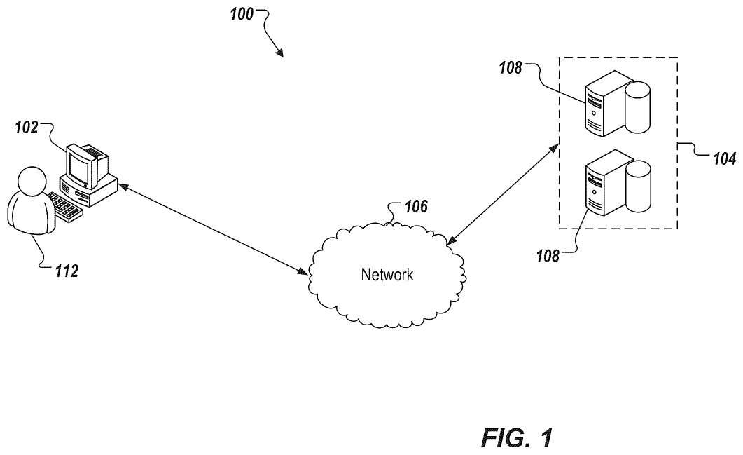

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, the server system 104 can provision at least a portion of a cloud platform, within which one or more instances of an application are to be deployed. In some examples, an installation package is provided for the application and includes an installation package that is build by a builder using a component packing function (compnt_pack). As described in further detail herein, the installation package is provisioned with an inner function (_compnt_pack_require_) and a mapping table (component_ids.json). In some examples, the installation package is absent any components. Instead, components can be stored in one or more component repositories. The installation package can be transmitted to a computing device within the cloud platform for installation. For example, an installer can process the installation package to execute a component retrieving function (compnt_require). In some examples, execution of the component retrieving function results in querying the mapping table to convert required component URLs to component UUIDs. In some examples, each UUID is passed as a parameter to the inner function (_compnt_pack_require_), which executes to load the component from a respective component repository.

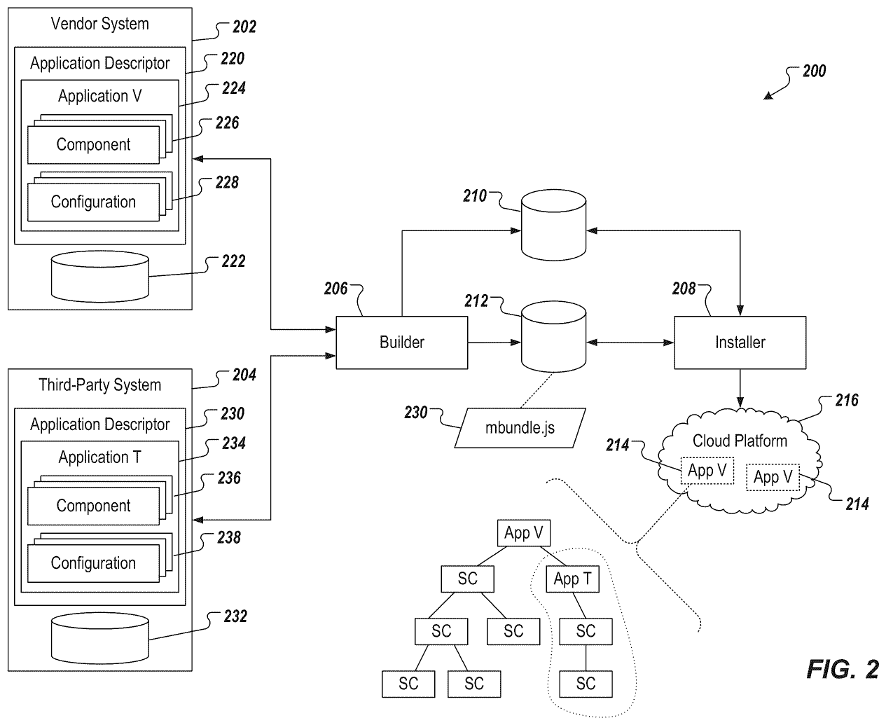

FIG. 2 depicts an example conceptual architecture 200 in accordance with implementations of the present disclosure. In the example of FIG. 2, the conceptual architecture 200 includes a vendor system 202, a third-party system 204, a builder 206, an installer 208, a component repository 210, and a package store 212. As described in further detail herein, an application 214 is deployed to a cloud platform 216. The example of FIG. 2 depicts multiple instances of the application 214 being deployed to the cloud platform 216. Also in the example of FIG. 2, the application 214 is provided by a vendor

(Application V, App V) and includes multiple components (sub-components). In the example of FIG. 2, one of the components includes an application that is provided by a third-party (Application T, App T). In some examples, the component repository 210 functions as a central repository to store components for each of multiple applications that can be deployed to the cloud platform 216.

In further detail, the vendor system 202 provisions the application 214 and the third-party provisions the third-party application. In the example of FIG. 2, the vendor system 202 provides an application descriptor 220 and a component repository 222. In some examples, the application descriptor 220 provides a definition 224 of the application 214. In some examples, the definition 224 in the application descriptor 220 specifies components 226 and configurations 228. For example, the components 226 can be specified in a list of components, each component being assigned a universally unique identifier (UUID). In some examples, the UUID is assigned during development of the component (e.g., using an integrated development environment (IDE)). In some examples, the configurations 228 specifies the setup of the components 226, their relationships, default parameters, required dependencies, and the like. In some examples, each component specified in the application descriptor 220 is stored in the component repository 222 and can be accessed through a uniform resource locator (URL) that points to the respective component within the component repository 222.

In the example of FIG. 2, the third-party system 204 provides an application descriptor 230 and a component repository 232. In some examples, the application descriptor 230 provides a definition 234 of the third-party application. In some examples, the definition 234 in the application descriptor 230 specifies components 236 and configurations 238. In some examples, the configurations 238 specifies the setup of the components 236, their relationships, default parameters, required dependencies, and the like. In some examples, each component specified in the application descriptor 230 is stored in the component repository 232 and can be accessed through a URL that points to the respective component within the component repository 222.

In accordance with implementations of the present disclosure, during build-time, the builder 206 processes the application descriptors 220, 230 to generate an installation package 230 for the application 214, which, in the example of FIG. 2, includes the third-party application nested therein. In some examples, the builder 206 accesses the application description 220 and the application description 230 to generate the installation package 230 and publishes the installation package 230 to the package store 218. Further, the components of the application 214 are stored in the component store 210, each being associated with a respective URL that points to their location. While the example of FIG. 2 represents an application having a third-party application nested therein, it is contemplated that implementations of the present disclosure can be realized in applications having no third-party applications nested therein, and/or applications having multiple third-party applications nested therein.

In accordance with implementations of the present disclosure, the builder 206 executes a component packing function (compnt_pack), which provides a component retrieval function (_compnt_pack_require_) in the installation package 230. In some examples, the component retrieval function is an inner function that it is nested within a containing (or outer) function. In some examples, the component packing function is provided through a plug-in to the builder 206 (e.g., having a class definition of {Generated NSApp}/compnt_pack.config.js, class ComponentsInfoPlugin). Further, the builder 206 provides a mapping table (component_ids.json) within the installation package 230. In some examples, the mapping table maps the URL of each component to the UUID assigned to the respective component. For example, the builder retrieves each component from the respective component repository 222, 232 based on the URL of the respective component.

In some examples, the builder 206 determines a UUID for the component and stores the component in the component repository 210 based on the UUID. For example, the builder 206 uses a hash function (any appropriate hash function) to build the mapping table as a hash table. In some examples, and for each component, the mapping table uses the URL as the key, and the UUID as a hash value (determined using the hash function) to map the location of the component. The builder 206 maps the URL to the UUID within the mapping table. Accordingly, and in contrast to traditional approaches, instead of physically packing all of the components of the application 214 into the installation package 230, the builder 206 embeds the inner function (_compnt_pack_require_) into the installation package 230, which enables retrieval of the components at runtime, as described in further detail herein. More particularly, in building the installation package 230, the builder 206 identifies components by their respective URLs. The mapping table enables the URLs to be converted to UUIDs for actual retrieval of the components from the central repository 210.

In some examples, during build-time, each component is annotated according to its hierarchical level in the respective application descriptor. In this manner, components can be differentiated with respect to components that are installed as making up a base version of the application, and components that can be installed later, when need (lazy loading).

In accordance with implementations of the present disclosure, during runtime, the installer retrieves the installation package 208 from the package store 212. For example, the installer 208 receive a command to install an instance of the application 214 in the cloud platform 208 and, in response, queries the package store 212 for the package 230. In some implementations, the installer 208 executes the installation package 230, which includes a component retrieving function (compnt_require). For example, the component retrieving function can execute to query the mapping table to convert required component URLs to component UUIDs. That is, for example, at runtime, the URL of each component is read from the installation package 208 and is converted to a UUID of the respective component using the mapping table. In some examples, each UUID is passed as a parameter to the inner function (_compnt_pack_require_), which executes to identify the particular component within and load the component from the component repository 210 and integrate the component into the installation package 230. Once needed components are received, the installer 208 installs an instance of the application 214 within the cloud platform.

In some examples, before retrieving a component from the central repository 210, the UUID of each component can be compared to a list of installed components, which records UUIDs of components that have already been installed by the installer 208. The list of installed components can be provided in a component configuration file at account level (e.g., a component configuration file that is specific to a tenant account, which lists the components already installed for a respective tenant). For example, these can include components of other applications that have previously been installed, which are also used by the application that is being installed. If it is determined that the component is already installed, the component is not again installed. In this manner, redundant copies of components is avoided.

In some implementations, the installer 208 installs a complete instance of the application 214. That is, the installer 208 installs all components of the application 214. In this manner, full functionality of the application 214 is provided from the outset. In some implementations, the installer 208 installs, at least initially, an incomplete instance of the application 214. That is, the installer 208 installs less than all components of the application 214. For example, the installer 208 can initially install a base version of the application 214 then retrieve and install other components as needed. Accordingly, functionality of components can be added on-demand (also referred to as lazy loading). If certain functionality is not needed, the component providing that functionality is not installed. In this manner, technical resources can be conserved through absence of components installed within the cloud platform 216.

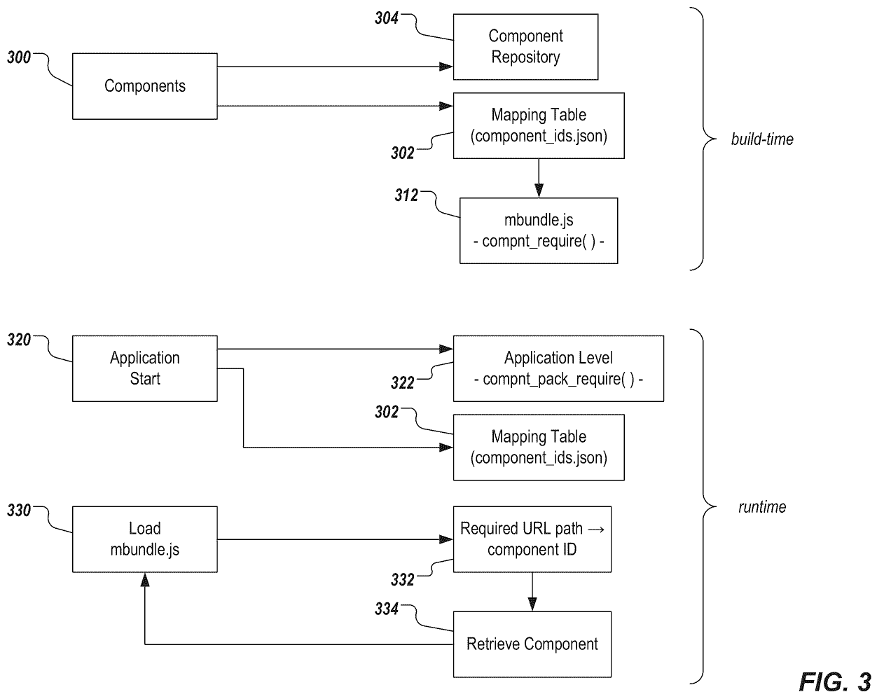

FIG. 3 depicts example respective representations of build-time and runtime of an application in accordance with implementations of the present disclosure. In the depicted example, a set of components 300 is represented and can include components that are part of an application (e.g., components identified in the application descriptors 220, 230 of FIG. 2). In some examples, a mapping table 302 is provided, which maps URLs of respective components to UUIDs of the respective components, which are stored in a component repository 304 (e.g., the component repository 210 of FIG. 2). Further, an installation package 312 (e.g., the installation package 230 of FIG. 2) is provided, which includes the component retrieving function (compnt_require) and the inner function (_compnt_pack_require_).

During runtime, an application start 320 represents triggering installation of the application (e.g., the application 214 of FIG. 2) in a cloud platform (e.g., the cloud platform 216 of FIG. 2). In some implementations, the inner function (_compnt_pack_require_) 322 is executed (e.g., by the installer 208) with reference to the mapping table 302. For example, a load 330 of components to the installation package is performed through execution of the inner function (_compnt_pack_require_), during which the mapping table is used to determine the UUID of each component, and each component is retrieved from a component repository (e.g., the component repository 210 of FIG. 2).

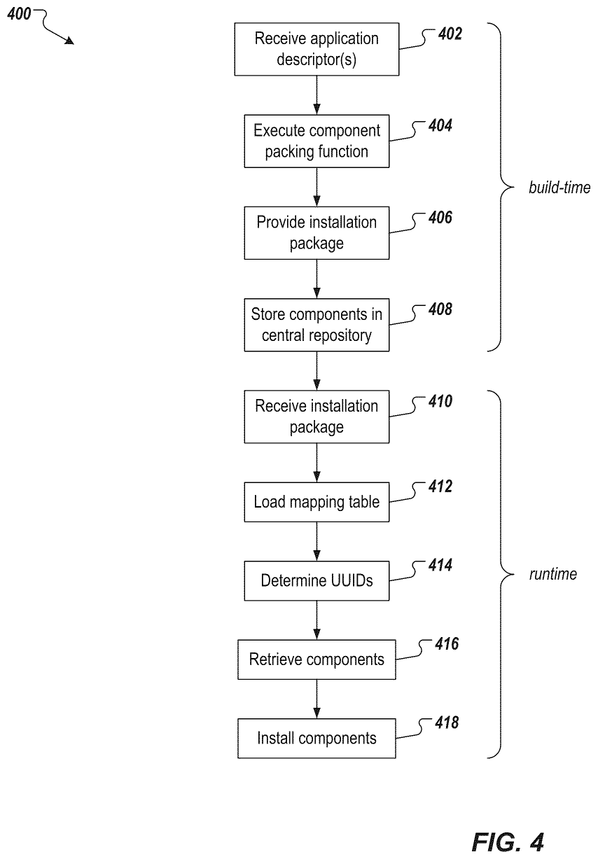

FIG. 4 depicts an example process 400 that can be executed in accordance with implementations of the present disclosure. In some examples, the example process 400 is provided using one or more computer-executable programs executed by one or more computing devices.

One or more application descriptors are received (402). For example, and as described in detail herein with reference to FIG. 2, the builder 206 can receive one or more application descriptors (e.g., the application descriptors 220, 230) from one or more systems (e.g., the vendor system 202, the third-party system 204). The one or more application descriptors describe an application that is to be installed in a cloud platform. A component packing function is executed (404). For example, and as described in detail herein, the builder 206 executes the component packing function (compnt_pack) to initiate component packing in accordance with implementations of the present disclosure. In some examples, the component packing function is provided through a plug-in to the builder 206.

An installation package is provided (406). For example, and as described in detail herein, the builder 206 generates the installation package 230 through execution of the component packing function (compnt_pack). The installation package 230 includes the inner function (_compnt_pack_require_) that can be subsequently executed at runtime to retrieve components. Further, a mapping table is provided, which maps URLs to UUIDs of respective components. Components are stored in a central repository (408). For example, and as described in detail herein, components that are to be installed for an instance of the application are stored in the component repository 210.

The installation package is received (410). For example, and as described in detail herein, the installer 230 receives the installation package 230 from the package store 212. The mapping table is loaded (412). For example, and as described in detail herein, the installer 208 loads the mapping table into memory. UUIDs of the components are determined (414). For example, and as described in detail herein, for each component, a URL is provided as input to the mapping table, which provides a respective UUID as output. Components are retrieved (416). For example, and as described in detail herein, the inner function (_compnt_pack_require_) receives each UUID as input and retrieves the respective components from the component repository 210. Components are installed (418). For example, and as described in detail herein, the installer 208 installs the components on a computing device (e.g., an application server) and configures the components to provide an instance of the application within the cloud platform.

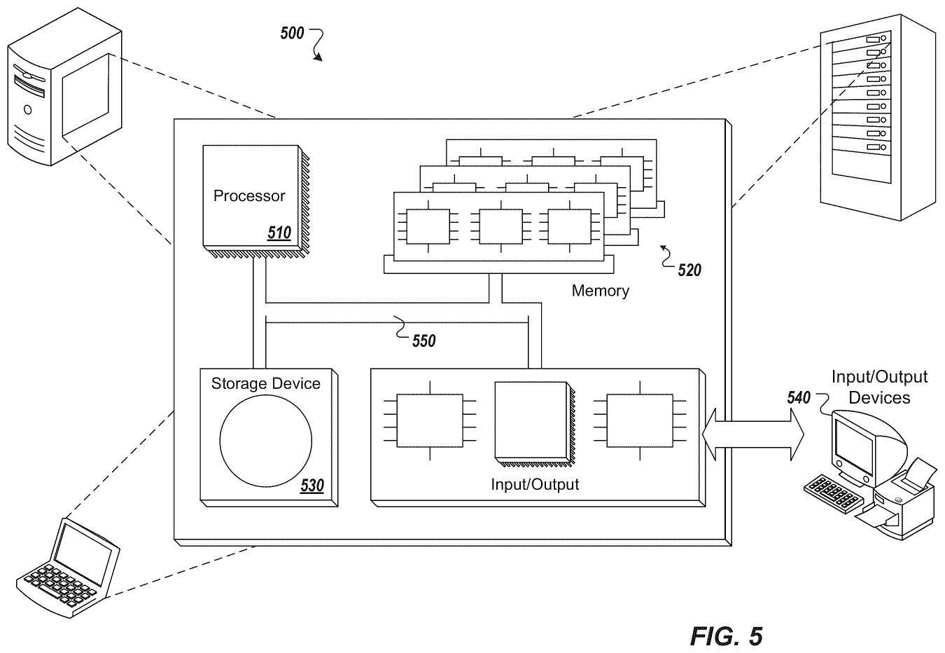

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for installing multi-component applications in cloud platforms, the method being executed by one or more processors and comprising:
during a build-time:
executing a component packing function to provide an installation package that is executable to install an instance of an application on a computing device, the installation package comprising an inner function that is executable to retrieve components in a set of components that provide functionality of the application, and
providing a mapping table that, for each component in the set of components, associates a locator to an identifier; and
during a runtime:
receiving, by an installer within a cloud platform, the installation package, and
processing, by the installer, the installation package to install a first instance of the application on a computing device of the cloud platform by:
determining, for at least one component in the set of components, a respective identifier based on a respective locator using the mapping table,
retrieving, by the inner function, the at least one component from a component repository based on the respective identifier, and
installing the at least one component on the computing device.

2. The method of claim 1, wherein each component in the set of components is stored in the component repository.

3. The method of claim 1, wherein the component repository is provided in multiple datacenters accessible to the cloud platform.

4. The method of claim 1, wherein a component in the set of components comprises a sub-application.

5. The method of claim 1, further comprising processing, by the installer, the installation package to install a second instance of the application on another computing device of the cloud platform.

6. The method of claim 1, wherein all components in the set of components are installed to provide the first instance of the application.

7. The method of claim 1, wherein a sub-set of components in the set of components is installed to provide the first instance of the application, and one or more components of the set of components are installed after the sub-set of components, in response to functionality of the one or more components being required during execution of the instance of the application.

8. A non-transitory computer-readable storage medium coupled to one or more processors and having instructions stored thereon which, when executed by the one or more processors, cause the one or more processors to perform operations for installing multi-component applications in cloud platforms, the operations comprising:
during a build-time:
executing a component packing function to provide an installation package that is executable to install an instance of an application on a computing device, the installation package comprising an inner function that is executable to retrieve components in a set of components that provide functionality of the application, and
providing a mapping table that, for each component in the set of components, associates a locator to an identifier; and
during a runtime:
receiving, by an installer within a cloud platform, the installation package, and
processing, by the installer, the installation package to install a first instance of the application on a computing device of the cloud platform by:
determining, for at least one component in the set of components, a respective identifier based on a respective locator using the mapping table,
retrieving, by the inner function, the at least one component from a component repository based on the respective identifier, and
installing the at least one component on the computing device.

9. The non-transitory computer-readable storage medium of claim 8, wherein each component in the set of components is stored in the component repository.

10. The non-transitory computer-readable storage medium of claim 8, wherein the component repository is provided in multiple datacenters accessible to the cloud platform.

11. The non-transitory computer-readable storage medium of claim 8, wherein a component in the set of components comprises a sub-application.

12. The non-transitory computer-readable storage medium of claim 8, wherein operations further comprise processing, by the installer, the installation package to install a second instance of the application on another computing device of the cloud platform.

13. The non-transitory computer-readable storage medium of claim 8, wherein all components in the set of components are installed to provide the first instance of the application.

14. The non-transitory computer-readable storage medium of claim 8, wherein a sub-set of components in the set of components is installed to provide the first instance of the application, and one or more components of the set of components are installed after the sub-set of components, in response to functionality of the one or more components being required during execution of the instance of the application.

15. A system, comprising:
a computing device; and
a computer-readable storage device coupled to the computing device and having instructions stored thereon which, when executed by the computing device, cause the computing device to perform operations for installing multi-component applications in cloud platforms, the operations comprising:
during a build-time:
executing a component packing function to provide an installation package that is executable to install an instance of an application on a computing device, the installation package comprising an inner function that is executable to retrieve components in a set of components that provide functionality of the application, the installation package being absent components, and
providing a mapping table that, for each component in the set of components, associates a locator to an identifier.

16. The system of claim 15, wherein each component in the set of components is stored in the component repository.

17. The system of claim 15, wherein the component repository is provided in multiple datacenters accessible to the cloud platform.

18. The system of claim 15, wherein operations further comprise, during a runtime:
receiving, by an installer within a cloud platform, the installation package; and
processing, by the installer, the installation package to install a first instance of the application on a computing device of the cloud platform by:
determining, for at least one component in the set of components, a respective identifier based on a respective locator using the mapping table,
retrieving, by the inner function, the at least one component from a component repository based on the respective identifier, and
installing the at least one component on the computing device.

19. The system of claim 18, wherein operations further comprise processing, by the installer, the installation package to install a second instance of the application on another computing device of the cloud platform.

20. The system of claim 15, wherein all components in the set of components are installed to provide the first instance of the application.
